(19) United States
(12) Patent Application Publication
(10) Pub. No.: US 2010/0075173 A1
(43) Pub. Date: Mar. 25, 2010

(54) METALLIC MULTILAYERED MATERIAL FOR USE AS A HEATING PLATE OR A COOLING PLATE

(75) Inventor: Jürgen Eberhard, Benningen (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: EISFINK MAX MAIER GMBH & CO. KG, Ludwigsburg (DE)

(21) Appl. No.: 12/520,080

(22) PCT Filed: Dec. 19, 2007
(86) PCT No.: PCT/EP2007/064177

§ 371 Date: Jun. 18, 2009

(30) Foreign Application Priority Data
Dec. 20, 2006 (DE) 20 2006 019 215.8

(51) Int. Cl. A47J 36/02; A47J 37/06; B32B 15/01; B32B 3/00

(52) U.S. Cl. 428/653; 428/172

(57) ABSTRACT

This invention describes a metallic multilayered material (10) for use as a heating plate or a cooling plate, in particular for food preparation, which is provided with at least one thick inner layer (12) made of good heat conducting material and and at least one thinner lower and upper cover layer (14, 16). The lower cover layer (14) has a plurality of holes (18) which are each filled at least partly with material of the inner layer (12). The upper cover layer (16) has no holes. The upper cover layer (16) of the multilayered material (10) serves as a work surface (e.g., as a grilling surface). Said multilayered material (10) guarantees, for example, a faster heat transfer to the open surface of the upper cover layer (16) during heating of the lower cover layer (14) by radiant heat or contact heat without the multilayered material (10) warping thereby.

This invention relates to a metallic multilayer material of the type indicated in the preamble of claim 1.

It is known (DE 201 16 711 U1) to manufacture a multilayer plate from such a multilayer material, which is preferably fabricated by rolling, and to use it as an induction grill plate. It is also possible to produce a cooking plate, a cook-top or the like from such multilayer material. This known multilayer material has two cover layers of stainless steel, of which at least one is made of ferritic steel, is heated inductively and is typically of a symmetrical configuration, hence including two cover layers of ferritic steel. There is usually no risk of the multilayer material warping in use, because in the induction heating process the heat is generated within the two cover layers of ferritic steel. In the event of such risk being nevertheless present, it is known from a cooking vessel bottom made of three-layered metal laminate (DE 33 36 736 C2) to provide the outer cover layers with unlike thickness in order to maintain a plane area of contact with the heat source.

Induction heating of grilling plates, cooking plates or cook-tops made from multilayer material incurs no problems and meanwhile has found widespread use. In contrast to contact or radiation heating however, induction heating necessitates a major engineering effort which is often neither desired nor justified. Unfortunately, multilayer material of the type initially referred to cannot be simply heated by radiation or contact heat. Because in this process the lower cover layer becomes substantially hotter than the upper cover layer, the risk of warping cannot be ruled out. While it could be contemplated to provide the cover layers with different thickness as on the known cooking vessel bottom, there would still be the problem that it takes too long for the heat to propagate from the lower cover layer through the inner layer to the upper cover layer. This applies even when a gas flame is used as radiation source or when a powerful radiator is firmly pressed against the free surface of the lower cover layer.

Whilst it is known in the art (U.S. Publication No. 2004/0118301 A1) to provide perforations in the lower cover layer of a grilling plate made of a multilayer material, this provision is not sufficient, for example in cases where contact heat is used, to achieve an adequately rapid propagation of heat from the heat source to the free surface of the upper cover layer without the multilayer material becoming warped.

It is an object of the present invention to provide a multilayer material of the type initially referred to in such a way that on heating the lower cover layer by radiation or contact heat a faster heat propagation to the free surface of the upper cover layer is attainable without however the multilayer material becoming warped in the process.

According to the present invention, this object is accomplished on a metallic multilayer material of the type initially referred to with the features indicated in claim 1.

Because in the multilayer material of the invention the lower cover layer includes a plurality of holes, each filled with material of the inner layer at least in part, the inner layer in the area of the holes is exposed relative to an external heat source used for heating and can therefore be heated in the area of the holes directly, bypassing so to speak the lower cover layer, so that the heat propagates to the upper cover layer substantially more rapidly. The case is similar when a cooling source is used for cooling the multilayer material instead of a heat source for heating it. The cooling source can be a blower which cools by blowing, or a cooling element which cools by contact.

Advantageous embodiments of the invention form the subject-matter of the subclaims.

When in one embodiment of the multilayer material of the invention the holes are filled flush with material of the inner layer, it is possible for a heating or cooling source to be effectively pressed against the free surface of the lower cover layer, thereby transferring heat or cold through direct contact directly to the inner layer and from there to the upper cover layer. A radiation heat source or a radiation cooling source may find equally efficient usage in this case. In addition, a more secure and longer lasting fastening of the lower cover layer to the inner layer is ensured.

When in another embodiment of the multilayer material of the invention each of the holes has the contour of a regular polygon, there is no risk that in the manufacturing of the multilayer material, which is preferably by rolling, the lower layer expands to some extent in the one or the other direction due to the holes and thereby warps. The same applies to the use of the multilayer material in operation.

When in another embodiment of the multilayer material of the invention the holes are arranged in a uniformly distributed pattern in columns and lines, the lands between the holes in the column and line directions are equally arranged at right angles to each other and in particular in a straight line, so that a tensile or elongation load exerted on the lands during the preferred rolling manufacturing process or in use is of equal magnitude in both directions and warping need not be feared. Tests conducted by applicant have revealed that when lines of holes are arranged in a staggered relationship to each other, warping results both during rolling and in use, because this produces a tortuous or meandering run of the lands between the lines, whilst in the direction of the columns the lands extend in a straight line. The adverse effect of the tortuous or meandering run of the lands in or parallel to the direction of the lines is greater still when the holes are configured as elongated holes. Such asymmetrical holes tend to be pulled apart in a direction transverse to their length during rolling. The tortuous or meandering run of the lands causes the material of the lower cover layer to be pulled apart in or parallel to the line direction on rolling or in use, similar to expanded metal.

When in another embodiment of the multilayer material of the invention the inner layer is made of aluminum and the two cover layers are made of stainless sheet steel, the multilayer material of the invention which is actually configured for use with radiation or contact heat sources or radiation or contact cooling sources is readily heatable also by induction. In addition, multilayer material in which the cover layers are made of stainless sheet steel meets prescribed food preparation hygiene standards optimally.

When in another embodiment of the multilayer material of the invention the holes occupy at least about two thirds of the area of the lower cover layer, an acceptable compromise is achieved between the contradictory requirements that on the one hand the lower cover layer be free of warping and on the other hand transfer heat or cold to the inner layer to good effect.

When in another embodiment of the multilayer material of the invention the two cover layers are configured to have about the same mass, the best compromise results for the two above-mentioned contradictory requirements.

When in another embodiment of the multilayer material of the invention the upper cover layer is thinner than the lower cover layer, the existing requirement that the two cover layers be made of the same amount of material or have the same mass can be best satisfied in view of the compromise to be achieved. Otherwise, to fulfill this requirement, materials of different density would have to be used for the two cover layers, the implementation of which would present greater difficulties in view of the above-named hygiene demands.

The general rule is that the heat transfer from the lower layer to the upper layer is the better the larger the area of the holes in the lower layer. While the lower layer does not serve for effective heat transfer to the upper layer (being rather an impediment in this regard), it is nevertheless necessary for the absorption of tension and prevention of warping of the multilayer material in use and in its preferred rolling manufacturing process.

Embodiments of the present invention will be described in more detail in the following with reference to the accompanying drawing. In the drawing,

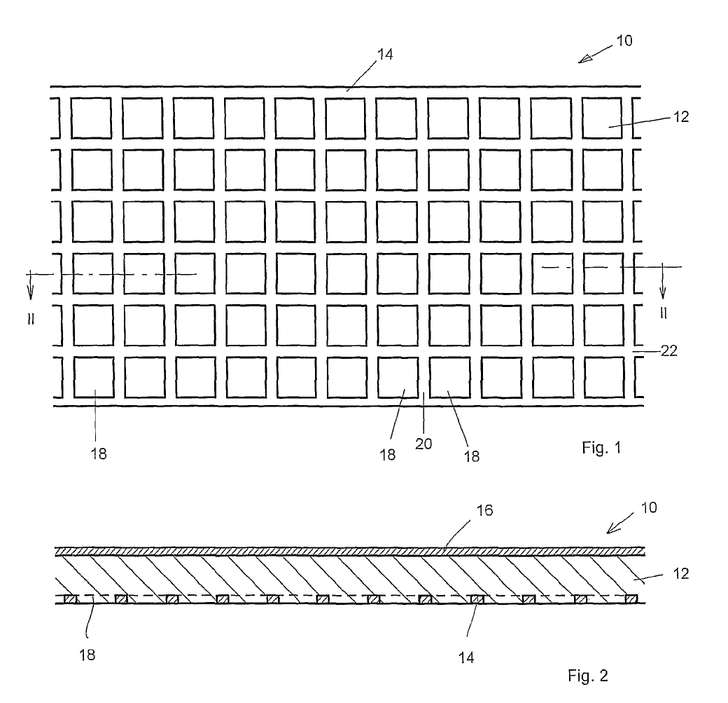

FIG. 1 is a view of the undersurface of a multilayer material of the invention; and

FIG. 2 is a sectional view taken along the line II-II of FIG. 1.

In FIGS. 1 and 2 a metallic multilayer material is designated generally as 10. It is manufactured as a sheet material of any desired size by rolling and cut to the desired plate size for use as a heating or cooling plate, particularly for food preparation. The multilayer material 10 includes at least one thick inner layer 12 of a material conducting heat well, such as aluminum, and at least one thinner lower and upper cover layer 14 and 16, respectively. The two cover layers 14, 16 are preferably made of stainless sheet steel. When the multilayer material is used as a grilling plate, the upper surface of the upper cover layer 16 provides the grilling area. Depending on the requirements, several sheet metal layers may be used to form the lower cover layer 14 and/or the upper cover layer 16. The lower cover layer 14 includes a plurality of holes 18. In the embodiment illustrated in the drawing, the holes 18 are filled flush with the material of the inner layer 12. This is achieved by the rolling process in which the preferably softer metallic material of the inner layer 12 is rolled into the holes 18 of the lower cover layer 14 which is preferably made from a harder material. It would be sufficient if the material of the inner layer 12 filled the holes 18 at least in part, having entered by rolling the holes 18 of the lower cover layer 14 to a depth amounting to at least part of the thickness of the lower cover layer 14. The upper layer 16 of the multilayer material 10 serves as working area (for example, as a grilling area) and therefore must be devoid of holes. Sufficient fastening between the upper layer 16 and the inner layer 12 is anyway achieved by the rolling operation. By contrast, the use of perforated sheet metal for the lower cover layer 14 serves primarily to improve the heat transfer not only from the lower cover layer 14 but in addition also from the underside of the inner layer 12 in the area of the holes 18 where the inner layer 12 is exposed, to the upper cover layer 16. This will be explained in greater detail further below.

Each of the holes 18 has the contour of a regular polygon which in the embodiment shown is a square. By definition, all sides of a regular polygon are of equal length and all internal angles are equal, and in each regular polygon a circle can be inscribed (incircle) having as tangents all the sides of the polygon, and a circle can be circumscribed (circumscribed circle) on which all the corners of the polygon lie (cf. Meyers Lexikon der Technik and der exakten Naturwissenschaften, 1970, page 2658). The holes 18 are arranged in a uniformly distributed pattern in columns and lines at right angles to one another, as becomes readily apparent from FIG. 1. Lands 20 between the columns of holes 18 and lands 22 between the lines of holes 18 therefore extend in a straight line and at right angles to one another. In connection with the configuration of the holes as regular polygons, it is thereby guaranteed, as initially explained, that any warping of the multilayer material and in particular of the lower layer 14 occurs neither during rolling nor in use. The holes 18 occupy at least about two thirds of the surface area of the lower cover layer 14. In addition, the two cover layers 14, 16 are configured to be of about equal mass. When the lower cover layer 14 and the upper cover layer 16 are made from the same material, the upper cover layer 16 is suitably made thinner than the lower cover layer 14 to satisfy the above-named demand. In the embodiment shown in the drawing, the two cover layers 14, 16 are of equal thickness. In an embodiment tested by applicant, the perforated sheet metal of the lower cover layer 14 had a thickness of 1.5 mm and the sheet metal of the upper cover layer 16 a thickness of 1 mm, while the sides of the square holes 18 had a length of 8 mm. Each of the lands 20, 22 had a width of 4 mm. The test has revealed that such a multilayer material does not warp, neither during rolling nor in use. In the embodiment illustrated in the drawing, the lands 20, 22 are more narrowly constructed which is why a still better heat transfer will result from the lower cover layer 14 through the inner layer 12 to the upper cover layer 16.

When the multilayer material 10 is used as heating plate for food preparation, for example, as a grilling plate, it is heated from the undersurface visible in FIG. 1, preferably by radiation or contact heat. Radiation heat, for example, can be efficiently transferred to the multilayer material 10 by the use of a gas flame. Contact heat, by contrast, is transferred to the multilayer material 10 suitably by pressing a radiator against the undersurface of the multilayer material 10. In the latter case, the holes 18 in the lower cover layer 14 suitably should be filled flush with the material of the inner layer 12 as shown in FIG. 2. In the event of the holes 18 being not filled to the full thickness of the lower cover layer 14 with the material of the inner layer 12, heating by means of a burner or a gas flame would be more appropriate than by transfer of contact heat. In all embodiments of the multilayer material 10, it can also be heated inductively provided that it is made of a material capable of induction, meaning for example, an inner layer 12 of aluminum and cover layers 14, 16 of stainless sheet steel. Considering however that in an inductively heated multilayer material the heat is generated within, that is, the heat does not have to be introduced through thermal transfer from the under-surface of the lower cover layer 14, induction heating practically does not incur the risk of warping of the multilayer material when the lower cover layer 14 is not a perforated sheet metal.

Instead of producing the multilayer material by rolling as in the above-described embodiments, it is also manufacturable by casting.

What is claimed is:

1. A metallic multilayer material for use as a heating or cooling plate, in particular for food preparation, which is provided with at least one thick inner layer of a material conducting heat well and at least one thinner lower and upper cover layer,
characterized in that the lower cover layer includes a plurality of holes, each filled with material of the inner layer at least in part and that the two cover layers are configured to have about the same mass.

2. The multilayer material according to claim 1, characterized in that the holes are filled flush with material of the inner layer

3. The multilayer material according to claim 1, characterized in that each of the holes has the contour of a regular polygon.

4. The multilayer material according to claim 2, characterized in that each of the holes has the contour of a regular polygon.

5. The multilayer material according to claim 1, characterized in that the holes are arranged in a uniformly distributed pattern, forming columns and lines at right angles to each other.

6. The multilayer material according to claim 2, characterized in that the holes are arranged in a uniformly distributed pattern, forming columns and lines at right angles to each other.

7. The multilayer material according to claim 3, characterized in that the holes are arranged in a uniformly distributed pattern, foaming columns and lines at right angles to each other.

8. The multilayer material according to claim 1, characterized in that the inner layer is made of aluminum and the two cover layers are made of stainless sheet steel.

9. The multilayer material according to claim 2, characterized in that the inner layer is made of aluminum and the two cover layers are made of stainless sheet steel.

10. The multilayer material according to claim 3, characterized in that the inner layer is made of aluminum and the two cover layers are made of stainless sheet steel.

11. The multilayer material according to claim 4, characterized in that the inner layer is made of aluminum and the two cover layers are made of stainless sheet steel.

12. The multilayer material according to claim 1, characterized in that the holes occupy at least about two thirds of the area of the lower cover layer.

13. The multilayer material according to claim 2, characterized in that the holes occupy at least about two thirds of the area of the lower cover layer.

14. The multilayer material according to claim 3, characterized in that the holes occupy at least about two thirds of the area of the lower cover layer.

15. The multilayer material according to claim 4, characterized in that the holes occupy at least about two thirds of the area of the lower cover layer.

16. The multilayer material according to claim 5, characterized in that the holes occupy at least about two thirds of the area of the lower cover layer.

17. The multilayer material according to claim 1, characterized in that the upper cover layer is thinner than the lower cover layer.
